(19) United States
(12) Patent Application Publication
(10) Pub. No.: US 2023/0261294 A1
(43) Pub. Date: Aug. 17, 2023

(54) SOLID STATE BATTERY

(71) Applicant: Murata Manufacturing Co., Ltd., Nagaokakyo-shi (JP)

(72) Inventors: Masayuki KOUZU, Nagaokakyo-shi (JP); Kenji OSHIMA, Nagaokakyo-shi (JP); Makoto YOSHIOKA, Nagaokakyo-shi (JP)

(21) Appl. No.: 18/308,094

(22) Filed: Apr. 27, 2023

Related U.S. Application Data
(63) Continuation of application No. PCT/JP21/42145, filed on Nov. 10, 2021.

(30) Foreign Application Priority Data
Nov. 10, 2020 (JP) 2020-187256

(51) Int. Cl. H01M 50/157; H01M 10/0525; H01M 10/0562

(52) U.S. Cl. CPC H01M 50/157; H01M 10/0525; H01M 10/0562

(57) ABSTRACT

A solid state battery that includes: a solid state battery laminate including at least one battery constituent unit, the at least one battery constituent unit including a positive electrode layer, a negative electrode layer, and a solid electrolyte layer interposed between the positive electrode layer and the negative electrode layer; a first external terminal on a first side surface of the solid state battery laminate; a second external terminal on a second side surface of the solid state battery laminate, the second side surface facing the first side surface across the solid state battery laminate; and an exterior member covering the solid state battery laminate, the exterior member including one or more pores on an inner side of the exterior member adjacent to the solid state battery laminate.

### CROSS REFERENCE TO RELATED APPLICATIONS

The present application is a continuation of International application No. PCT/JP2021/042145, filed Nov. 10, 2021, which claims priority to Japanese Patent Application No. 2020-187256, filed Nov. 10, 2020, the entire contents of each of which are incorporated herein by reference.

### FIELD OF THE INVENTION

The present invention relates to a solid state battery. More specifically, the present invention relates to a solid state battery in which an exterior member is provided so as to cover a solid state battery laminate.

### BACKGROUND OF THE INVENTION

Hitherto, secondary batteries that can be repeatedly charged and discharged have been used for various purposes. For example, secondary batteries are used as power sources of electronic devices such as smartphones and notebooks.

In secondary batteries, a liquid electrolyte is generally used as a medium for ion transfer contributing to charging and discharging. That is, a so-called electrolytic solution is used for the secondary battery. However, in such a secondary battery, safety is generally required from the viewpoint of preventing leakage of an electrolytic solution. Since an organic solvent or the like used for the electrolytic solution is a flammable substance, safety is required also in that respect.

Therefore, a solid state battery using a solid electrolyte instead of the electrolytic solution has been studied.
Patent Document 1: Japanese Patent Application Laid-Open No. 2015-220106
Patent Document 2: Japanese Patent Application Laid-Open No. 2015-220107

### SUMMARY OF THE INVENTION

The inventors of the present application have noticed that conventional solid state batteries have problems to be overcome, and have found the need to take measures therefor. Specifically, the inventors of the present application have found that there are the following problems.

For example, as illustrated in FIG. 15, a conventional solid state battery 100 includes, for example, a solid state battery laminate (or a battery main body) including at least one battery constituent unit 105 along a stacking direction, the at least one battery constituent unit including a positive electrode layer 101, a negative electrode layer 102, and a solid electrolyte layer 103 interposed therebetween. Such a battery main body includes, for example, an inorganic layer such as a silicon oxynitride thin film formed by sputtering as a waterproof layer 110 having a thickness of about 5 to 1000 nm. According to the research by the inventors of the present application, it has been found that the waterproof layer 110 having such a film thickness cannot withstand the stress generated by the volume expansion or contraction of the battery main body at the time of charging and discharging the solid state battery, and cracking, chipping, or the like may occur. According to the research of the inventors of the present application, it has also been found that, when cracking, chipping, or the like occurs in the waterproof layer 110 including such an inorganic layer, moisture or water vapor enters the battery main body and the performance of the solid state battery is significantly deteriorated.

In the conventional solid state battery 100, a resin layer 120 formed of silicone rubber, fluororesin, or the like may be further provided on the upper side of the waterproof layer 110, but in such a resin layer 120, water vapor may permeate, and water vapor may enter the battery main body, and it was also found by the research of the inventors of the present application that the gas barrier properties are insufficient.

The present invention has been devised in view of such problems. That is, a main object of the present invention is to provide a solid state battery including an exterior member capable of suppressing occurrence of cracking, chipping, or the like and having further improved gas barrier properties.

The inventors of the present application have attempted to solve the above problems by addressing the problems in a new direction instead of addressing the problems in an extension of the conventional technique. As a result, the invention of a solid state battery which has achieved the above-mentioned main purpose has been reached.

The solid state battery according to one aspect of the present invention includes: a solid state battery laminate including at least one battery constituent unit, for example, along a stacking direction, the at least one battery constituent unit including a positive electrode layer, a negative electrode layer, and a solid electrolyte layer interposed between the positive electrode layer and the negative electrode layer; a first external terminal on a first side surface of the solid state battery laminate; a second external terminal on a second side surface of the solid state battery laminate, the second side surface facing the first side surface across the solid state battery laminate; and an exterior member covering the solid state battery laminate, the exterior member including one or more pores on an inner side of the exterior member adjacent to the solid state battery laminate.

In the present invention, it is possible to obtain a solid state battery including an exterior member capable of suppressing or preventing occurrence of cracking, chipping, or the like and having further improved gas barrier properties against water vapor and the like. It is to be noted that the effects described in the present specification are considered by way of example only, and are not to be considered limited, and additional effects may be provided.

### BRIEF EXPLANATION OF THE DRAWINGS

FIG. 1 is a schematic view schematically illustrating a solid state battery laminate that can be used in a solid state battery according to an embodiment of the present invention.

FIG. 2 is a schematic sectional view schematically illustrating an exterior member that can be used in the solid state battery according to the embodiment of the present invention.

FIG. 3 is a schematic sectional view schematically illustrating another exterior member that can be used in the solid state battery according to the embodiment of the present invention.

FIG. 4 is a schematic sectional view schematically illustrating an exterior member that can be used in a solid state battery according to another embodiment of the present invention.

FIG. 5 is a schematic sectional view schematically illustrating another exterior member that can be used in the solid state battery according to another embodiment of the present invention.

FIG. 6 is a schematic sectional view schematically illustrating a solid state battery according to an embodiment of the present invention.

FIG. 7 is a schematic sectional view schematically illustrating a solid state battery according to another embodiment of the present invention.

FIG. 8 is a photograph showing a part of a sectional surface of a solid state battery according to an embodiment of the present invention.

FIGS. 9(A) to 9(D) are schematic views schematically illustrating presence of a pore in an exterior member.

FIG. 10 schematically illustrates formation of a cut surface in sectional observation of an exterior member.

FIG. 11 shows a sample of an electron micrograph (SEM) showing a sectional surface of a solid state battery (scale bar: 10 μm).

FIG. 12 shows “exterior member (inner side)” and “exterior member (outer side)” separately in a sample of an electron micrograph (SEM) showing a sectional surface of a solid state battery (scale bar: 10 μm).

FIG. 13 shows a state where both “exterior member (inner side)” and “exterior member (outer side)” are binarized in a sample of an electron micrograph (SEM) showing a sectional surface of a solid state battery.

FIG. 14(A) shows a sample of an electron micrograph (SEM) showing a sectional surface of a solid state battery, FIG. 14(B) shows a state where a boundary between “exterior member (inner side)” and “battery main body (solid state battery laminate)” in the sample is clarified and binarized, and FIG. 14(C) a state where “exterior member (outer side)” is binarized together with “exterior member (inner side)” are binarized without clarifying the boundary between “exterior member (inner side)” and “battery main body (solid state battery laminate)”.

FIG. 15 is a schematic sectional view schematically illustrating a conventional solid state battery.

### DETAILED DESCRIPTION OF THE INVENTION

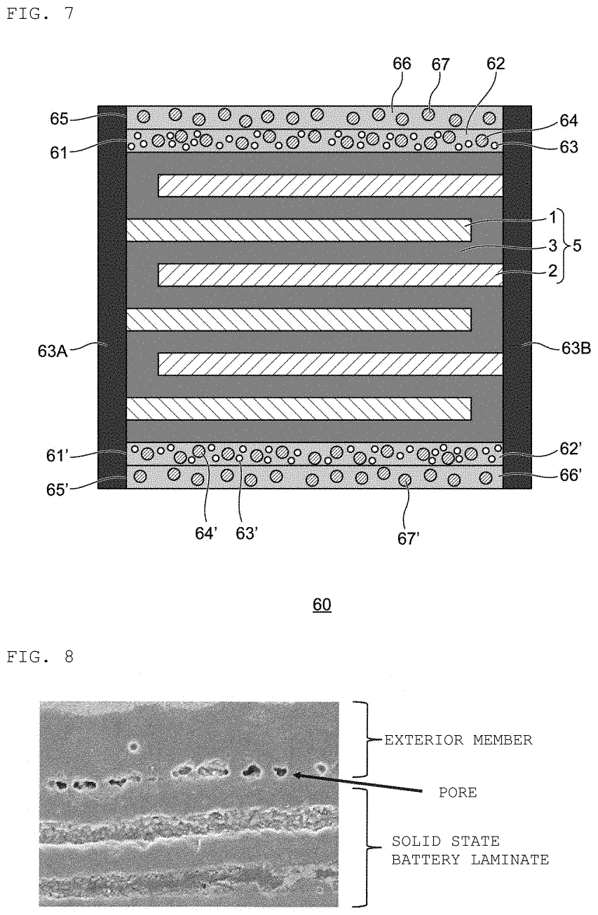

Hereinafter, a “solid state battery” (for example, a solid state battery specifically illustrated in FIG. 6 and FIG. 7) of the present invention, particularly, an “exterior member” (for example, an exterior member illustrated in FIGS. 2 to 5) covering a solid state battery laminate included in the solid state battery will be described in detail. Although description will be made with reference to the drawings as necessary, the shown contents are only schematically and exemplarily illustrated for the understanding of the present invention, and the appearance, the dimensional ratio, and the like may be different from the actual ones.

The term “sectional view” as used herein is based on a form (briefly, for example, a form in the case of being cut along a plane parallel to the thickness direction) where an object is viewed from a direction substantially perpendicular to an arbitrary thickness direction of the solid state battery.

The “vertical direction” and “horizontal direction” used directly or indirectly in the present description respectively correspond to the vertical direction and horizontal direction in the drawings.

The term “front-back direction” directly or indirectly used here corresponds to a front and back direction of the paper surface in the drawing.

Unless otherwise specified, the same reference signs or symbols denote the same members or sites, or the same semantic contents.

In a preferred aspect, it can be understood that a downward direction in a vertical direction (that is, a direction in which gravity acts) corresponds to a “downward direction”/a “bottom surface side”, and an opposite direction thereof corresponds to an “upward direction”/a “top surface side”.

The term “solid state battery” used in the present invention refers to, in a broad sense, a battery whose electrolyte as a constituent element is composed of solid and refers to, in a narrow sense, all solid state battery whose constituent elements (particularly preferably all constituent elements) are composed of solid. In a preferred aspect, the solid state battery in the present invention is a stacked solid state battery configured such that layers constituting a battery constituent unit are stacked with each other, and preferably such layers are composed of a sintered body. The “solid state battery” includes not only a so-called “secondary battery” capable of repeating charging and discharging but also a “primary battery” capable of only discharging. According to a preferred aspect of the present invention, the “solid state battery” is a secondary battery. The “secondary battery” is not excessively limited by its name, and can include, for example, a power storage device.

Hereinafter, first, a basic configuration of a “solid state battery” of the present invention will be described, and then characteristics (particularly, an “exterior member”) of the solid state battery of the present invention will be described. The configuration of the solid state battery described here is merely an example for understanding the invention, and does not limit the invention.

[Basic Configuration of Solid State Battery]

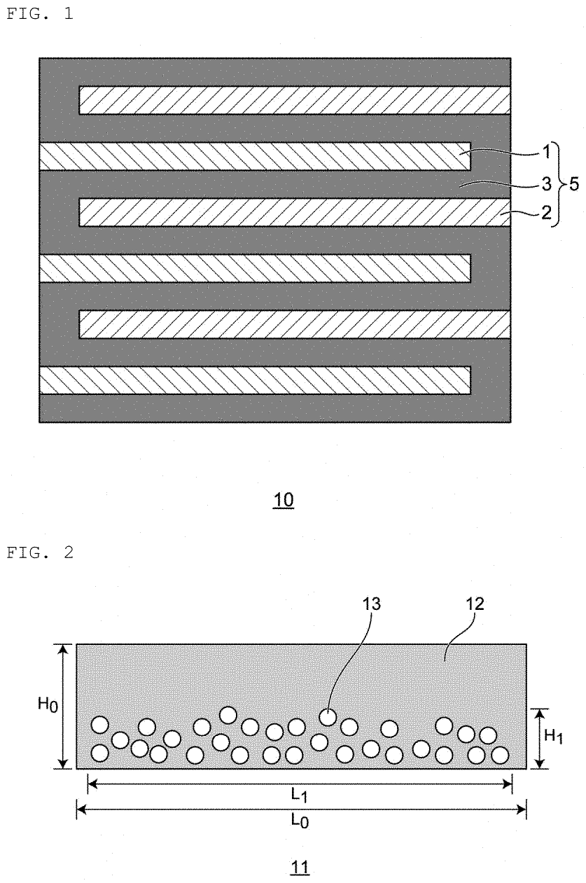

The solid state battery includes at least electrode layers of a positive electrode and a negative electrode and a solid electrolyte layer (or a solid electrolyte). Specifically, as illustrated in FIG. 1, the solid state battery includes a solid state battery laminate 10 (hereinafter, also referred to as “battery main body” in some cases) including at least one battery constituent unit 5 along a stacking direction, the at least one battery constituent unit including a positive electrode layer 1, a negative electrode layer 2, and a solid electrolyte layer (or a solid electrolyte) 3 interposed between the positive electrode layer 1 and the negative electrode layer 2.

In the solid state battery of the present disclosure, the laminate structure of the battery, particularly, the structure of the battery constituent unit is not particularly limited.

The solid state battery of the present disclosure may be a single battery including only a battery constituent unit composed of a positive electrode layer, a negative electrode layer, and a solid electrolyte layer (or a solid electrolyte) interposed therebetween.

In the solid state battery of the present disclosure, such battery constituent units may be arranged in series or in parallel. From the viewpoint of stress dispersion, the battery constituent units may be arranged in parallel.

Preferably, in the solid state battery, each layer constituting the solid state battery may be formed by firing, and a positive electrode layer, a negative electrode layer, a solid electrolyte layer, and the like may form a sintered layer. For example, the positive electrode layer, the negative electrode layer, and the solid electrolyte layer are fired integrally with each other, and therefore the solid state battery laminate may form an integrally sintered body.

The positive electrode layer 1 is an electrode layer containing at least a positive electrode active material. Therefore, the positive electrode layer 1 may be a positive electrode active material layer mainly containing a positive electrode active material. The positive electrode layer may further contain a solid electrolyte as necessary. In one aspect, the positive electrode layer may be composed of a sintered body containing at least positive electrode active material particles and solid electrolyte particles.

On the other hand, the negative electrode layer 2 is an electrode layer containing at least a negative electrode active material. Therefore, the negative electrode layer 2 may be a negative electrode active material layer mainly containing a negative electrode active material. The negative electrode layer may further contain a solid electrolyte as necessary. In one aspect, the negative electrode layer may be composed of a sintered body containing at least negative electrode active material particles and solid electrolyte particles.

The positive electrode active material and the negative electrode active material are materials involved in occlusion and release of ions and transfer of electrons to and from an external circuit in a solid state battery. For example, through the solid electrolyte, ions move (conduct) between the positive electrode layer and the negative electrode layer. The occlusion and release of ions in an active material is accompanied by oxidation or reduction of the active material, but charging and discharging proceed as electrons or holes for such oxidation-reduction reaction are transferred from an external circuit to an external terminal of the solid state battery, and further to the positive electrode layer or the negative electrode layer. The positive electrode layer and the negative electrode layer may be particularly layers capable of occluding and releasing lithium ions or sodium ions. That is, the solid state battery may be an all-solid-state secondary battery in which lithium ions or sodium ions can move between the positive electrode layer and the negative electrode layer with the solid electrolyte interposed therebetween to charge and discharge the battery.

(Positive Electrode Active Material)

Examples of the positive electrode active material that can be contained in the positive electrode layer 1 include at least one selected from the group consisting of a lithium-containing phosphate compound having a NaSICON-type structure, a lithium-containing phosphate compound having an olivine-type structure, a lithium-containing layered oxide, a lithium-containing oxide having a spinel-type structure, and the like. Examples of the lithium-containing phosphate compound having a NASICON-type structure include Li₃V₂(PO₄)₃. Examples of the lithium-containing phosphate compound having an olivine-type structure include Li₃Fe₂(PO₄)₃, LiFePO₄, LiMnPO₄, and LiFe_{0.6}Mn_{0.4}PO₄. Examples of the lithium-containing layered oxide include LiCoO₂, LiCo_{1/3}Ni_{1/3}Mn_{1/3}O₂, and LiCo_{0.8}Ni_{0.15}Al_{0.05}O₂. Examples of the lithium-containing oxide having a spinel-type structure include LiMn₂O₄ and LiNi_{0.5}Mn_{1.5}O₄.

Examples of the positive electrode active material capable of occluding and releasing sodium ions include at least one selected from the group consisting of a sodium-containing phosphate compound having a NASICON-type structure, a sodium-containing phosphate compound having an olivine-type structure, a sodium-containing layered oxide, a sodium-containing oxide having a spinel-type structure, and the like.

(Negative Electrode Active Material)

Examples of the negative electrode active material that can be contained in the negative electrode layer 2 include at least one selected from the group consisting of an oxide containing at least one element selected from the group consisting of Ti, Si, Sn, Cr, Fe, Nb, and Mo, a carbon material such as graphite, a graphite-lithium compound, a lithium alloy, a lithium-containing phosphate compound having a NaSICON-type structure, a lithium-containing phosphate compound having an olivine-type structure, a lithium-containing oxide having a spinel-type structure, and the like. Examples of the lithium alloy include Li—Al. Examples of the lithium-containing phosphate compound having a NASICON-type structure include Li₃V₂(PO₄)₃ and LiTi₂(PO₄)₃. Example of the lithium-containing phosphate compound having an olivine-type structure include Li₃Fe₂(PO₄)₃ and LiCuPO₄. Examples of the lithium-containing oxide having a spinel-type structure include Li₄Ti₅O₁₂.

Examples of the negative electrode active material capable of occluding and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The positive electrode layer and/or the negative electrode layer may contain a conduction aid. Examples of the conduction aid that can be contained in the positive electrode layer and the negative electrode layer may include at least one selected from the group consisting of metal materials such as silver, palladium, gold, platinum, copper, and nickel, carbon, and the like.

The positive electrode layer and/or the negative electrode layer may further contain a sintering aid. Examples of the sintering aid include at least one selected from the group consisting of lithium oxide, sodium oxide, potassium oxide, boron oxide, silicon oxide, bismuth oxide, and phosphorus oxide.

(Solid Electrolyte)

The solid electrolyte 3 is, for example, a material capable of conducting lithium ions or sodium ions. In particular, the solid electrolyte constituting the battery constituent unit in the solid state battery forms a layer through which, for example, lithium ions can conduct between the positive electrode layer and the negative electrode layer. Specific examples of the solid electrolyte include a lithium-containing phosphate compound having a NaSICON-type structure, an oxide having a perovskite-type structure, an oxide having a garnet-type or garnet-type similar structure, and an oxide glass ceramic-based lithium ion conductor. Examples of the lithium-containing phosphate compound having a NaSICON-type structure include LiₓM_{y}(PO₄)₃ (1≤x≤2, 1≤y≤2, and M is at least one selected from the group consisting of Ti, Ge, Al, Ga, and Zr). Examples of the lithium-containing phosphate compound having a NaSICON-type structure include Li_{1.2}Al_{0.2}Ti_{1.8}(PO₄)₃. Examples of the oxide having a perovskite-type structure include La_{0.55}Li_{0.35}TiO₃. Examples of the oxide having a garnet-type or garnet-type similar structure include Li₇La₃Zr₂O₁₂. As the oxide glass ceramic-based lithium ion conductor, for example, a phosphate compound (LATP) containing lithium, aluminum, and titanium as constituent elements, and a phosphate compound (LAGP) containing lithium, aluminum, and germanium as constituent elements can be used.

Examples of the solid electrolyte capable of conducting sodium ions include a sodium-containing phosphate compound having a NaSICON-type structure, an oxide having a perovskite-type structure, and an oxide having a garnet-type or garnet-type similar structure. Examples of the sodium-containing phosphate compound having a NaSICON-type structure include NaₓM_{y}(PO₄)₃ (1≤x≤2, 1≤y≤2, and M is at least one selected from the group consisting of Ti, Ge, Al, Ga, and Zr).

The solid electrolyte layer may contain a sintering aid. The sintering aid that can be contained in the solid electrolyte layer may be selected from, for example, materials similar to the sintering aid that can be contained in the positive electrode layer and/or the negative electrode layer.

(Positive Electrode Current Collecting Layer and Negative Electrode Current Collecting Layer)

The positive electrode layer 1 and the negative electrode layer 2 may each include a positive electrode current collecting layer and a negative electrode current collecting layer. Each of the positive electrode current collecting layer and the negative electrode current collecting layer may have a form of a foil, but may have a form of a sintered body from the viewpoint of reducing the manufacturing cost of the solid state battery by integral firing and reducing the internal resistance of the solid state battery. When the positive electrode current collecting layer and the negative electrode current collecting layer have a form of a sintered body, the positive electrode current collecting layer and the negative electrode current collecting layer may be formed of a sintered body containing a conduction aid and a sintering aid. The conduction aid that can be contained in the positive electrode current collecting layer and the negative electrode current collecting layer may be selected from, for example, materials similar to the conduction aid that can be contained in the positive electrode layer and/or the negative electrode layer. The sintering aid that can be contained in the positive electrode current collecting layer and/or the negative electrode current collecting layer may be selected from, for example, materials similar to the sintering aid that can be contained in the positive electrode layer and/or the negative electrode layer. In the solid state battery, the positive electrode current collecting layer and/or the negative electrode current collecting layer is not essential, and a solid state battery in which such a positive electrode current collecting layer and/or negative electrode current collecting layer is not provided is also conceivable. That is, the solid state battery in the present invention may be a solid state battery “without current collecting”.

(External Terminal)

The solid state battery laminate 10 may be provided with a terminal for connection with the outside (or an external device) (hereinafter, referred to as “external terminal”). In particular, it is preferable that a terminal for connection with the outside is provided as an “end face electrode” on a side surface of the solid state battery laminate 10. More specifically, as the external terminal, a terminal (positive electrode terminal) on a positive electrode side electrically connected to the positive electrode layer 1 and a terminal (negative electrode terminal) on a negative electrode side electrically connected to the negative electrode layer 2 may be provided (see, for example, 53A and 53B in FIGS. 6 and 63A and 63B in FIG. 7). Such a terminal preferably includes a material having high conductivity (or a conductive material). The material of the external terminal is not particularly limited, and examples thereof include at least one selected from the group consisting of gold, silver, platinum, tin, nickel, copper, manganese, cobalt, iron, titanium, and chromium.

[Features of Solid State Battery of Present Disclosure]

A solid state battery according to an embodiment of the present disclosure (hereinafter, also referred to as “solid state battery of the present disclosure” or simply as “solid state battery” or “battery” in some cases) includes, for example, as illustrated in FIG. 1, a solid state battery laminate 10 (hereinafter, also referred to as “battery main body” in some cases) including, as basic constituent elements, at least one battery constituent unit 5 along a stacking direction (or the thickness direction or the vertical direction), the at least one battery constituent unit including a positive electrode layer 1, a negative electrode layer 2, and a solid electrolyte layer (or a solid electrolyte) 3 interposed between the positive electrode layer 1 and the negative electrode layer 2. The solid state battery of the present disclosure can include, for example, a positive electrode terminal and a negative electrode terminal as an external terminal that can be provided on each of right and left side surfaces facing each other of the solid state battery laminate (more specifically, see an external terminal 53 of an embodiment illustrated in FIG. 6 (more specifically, a positive electrode terminal 53A and a negative electrode terminal 53B) and an external terminal 63 illustrated in FIG. 7 (more specifically, a positive electrode terminal 63A and a negative electrode terminal 63B)).

For example, as illustrated in FIG. 2, the solid state battery of the present disclosure preferably includes an exterior member 11 covering the battery main body. It is preferable that pores 13 are present on a side adjacent to the battery main body on the inner side of (or inside) the exterior member 11 (more specifically, see also pores (53, 53′) and the like that can be contained in an exterior member (51, 51′) of an embodiment illustrated in FIG. 6).

In the present disclosure, “the side adjacent to the battery main body (or the solid state battery laminate) on the inner side of the exterior member” basically means a portion or a region that is on the inner side of the exterior member or inside the exterior member and geometrically close to or in contact with the battery main body or the interface (the interface between the exterior member and the battery main body).

In the present disclosure, “the side adjacent to the battery main body (or the solid state battery laminate) on the inner side of the exterior member” may also include a portion where the exterior member is in contact with the battery main body, a boundary or interface between the exterior member and the battery main body, and another layer that can be formed between the exterior member and the battery main body (for example, an intermediate layer or mixed layer that can be formed during manufacturing).

In the present disclosure, terms “boundary” and “interface” basically mean a geometric boundary between the exterior member and the battery main body. Such a boundary may also be included in “the side adjacent to the battery main body (or the solid state battery laminate) on the inner side of the exterior member”.

For example, it is preferable that the pore 13 are present in an inner region of the exterior member 11 (see FIG. 2).

In the present disclosure, the term “inner region” refers to a region of the exterior member on a side close to the battery main body. More specifically, a region indicated by a height H₁ in FIG. 2 can be referred to as the “inner region”. Therefore, in the present disclosure, a region of the exterior member on a side far from the battery main body can be referred to as an “outer region”.

In the present disclosure, the “inner region” may also include a portion where the exterior member is in contact with the battery main body, a boundary or interface between the exterior member and the battery main body, and another layer that can be formed between the exterior member and the battery main body (for example, an intermediate layer or mixed layer that can be formed during manufacturing).

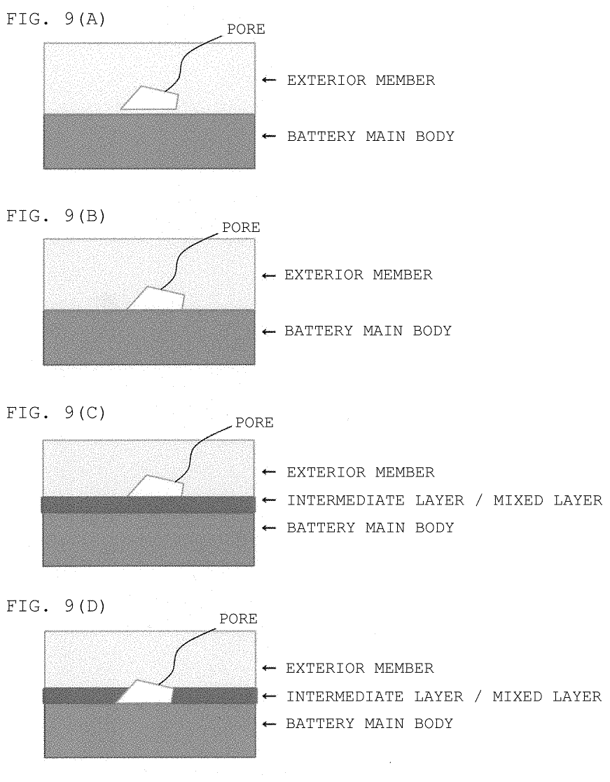

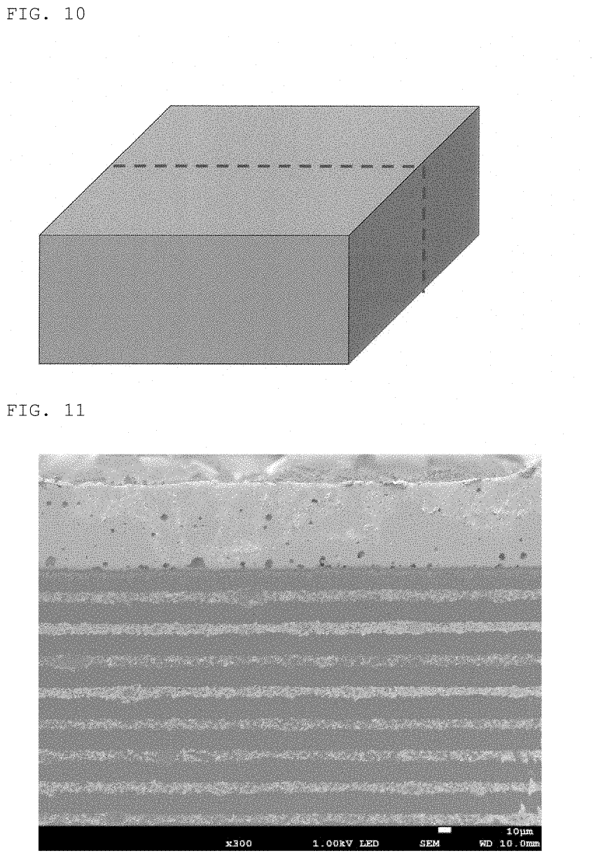

“A pore is present on the side adjacent to the battery main body (or the solid state battery laminate) on the inner side of the exterior member” and “a pore is present in the inner region of the exterior member” will be briefly described with reference to, for example, FIG. 9.

FIG. 9(A) schematically shows a typical case where a pore is present on the inner side of the exterior member. The shape of the pore may be irregular, regular or geometric.

In the present disclosure, also in such a case, it can be interpreted that “a pore is present on the side adjacent to the battery main body (or the solid state battery laminate) on the inner side of the exterior member” or “a pore is present in the inner region of the exterior member”.

FIG. 9(B) schematically shows a typical case where a pore is present in a portion where the exterior member is in contact with the battery main body. As shown in FIG. 9(B), at least a part of the pore may be present in contact with a boundary or interface between the exterior member and the battery main body.

In the present disclosure, also in such a case, it can be interpreted that “a pore is present on the side adjacent to the battery main body (or the solid state battery laminate) on the inner side of the exterior member” or “a pore is present in the inner region of the exterior member”.

FIG. 9(C) shows a case where a pore is present on the inner side of the exterior member. However, in FIG. 9(C), an intermediate layer or mixed layer is positioned between the exterior member and the battery main body, as another layer that can be formed during manufacturing. The thickness of the intermediate layer, the mixed layer, or the like is not particularly limited. In FIG. 9(C), at least a part of the pore is present in contact with a boundary or interface between the exterior member and the intermediate layer or the mixed layer.

In the present disclosure, the “intermediate layer or mixed layer that can be formed during manufacturing” means any layer that can be formed during manufacturing and can be positioned between the exterior member and the battery main body (or the solid state battery laminate), and may be a layer in which components or elements that can be contained in the exterior member and components or elements that can be contained in the battery main body (or the solid state battery laminate) are mixed.

In the present disclosure, also in such a case, it can be interpreted that “a pore is present on the side adjacent to the battery main body (or the solid state battery laminate) on the inner side of the exterior member” or “a pore is present in the inner region of the exterior member”.

FIG. 9(D) shows that a pore is present in an intermediate layer or mixed layer that can be formed between the battery main body and the exterior member. In such a pore, at least a part of the pore may be present in contact with a boundary or interface between the exterior member and the battery main body.

In the present disclosure, also in such a case, it can be interpreted that “a pore is present on the side adjacent to the battery main body (or the solid state battery laminate) on the inner side of the exterior member” or “a pore is present in the inner region of the exterior member”.

Hereinafter, with reference to FIG. 2, the solid state battery of the present disclosure, particularly, the “exterior member” that can include such a pore, particularly the “glass component” will be described in more detail.

The exterior member 11 illustrated in FIG. 2 can cover the periphery of the battery main body, more specifically, can cover all the peripheral surfaces of the battery main body except for the right and left side surfaces (or end surfaces) on which the external terminal is provided (more specifically, see an exterior member (51, 51′) illustrated in FIG. 6). For example, as illustrated in FIG. 2, the exterior member 11 contains a glass component 12, which will be described in detail below, as a base material or a matrix, and can function as a covering layer of the battery main body.

The solid state battery laminate, that is, the battery main body is disposed below the exterior member 11 illustrated in FIG. 2 adjacent to or in contact with (for example, in direct contact with) the exterior member (see, for example, FIG. 6).

For example, as illustrated in FIG. 2, the solid state battery of the present disclosure is mainly characterized in that the pores 13 are present in the inner region (for example, a lower side of the exterior member 11 illustrated in FIG. 2) adjacent to the battery main body (for example, the solid state battery laminate 10 in FIG. 1) (or an interface) on the inner side of (or inside) the exterior member 11 (more specifically, see FIG. 8). For convenience of description, the pore 13 is illustrated in the shape of a sphere having a circular sectional surface, but the shape of the pore 13 is not necessarily limited to a sphere.

For example, as illustrated in FIG. 2, when the pores 13 are unevenly distributed in the inner region of the exterior member 11, the stress that may be generated by volume expansion or contraction of the battery main body at the time of charging and discharging the solid state battery can be alleviated by the pores 13 serving as a cushion. Thus, cracking or chipping of the exterior member 11 can be suppressed or prevented, and as a result, entry of water vapor or moisture into the battery main body can be suppressed or prevented. That is, the gas barrier properties against water vapor and the like can be further enhanced by the pore 13.

In the solid state battery of the present disclosure, it is preferable that the outer region, preferably the outer half (an upper half), of the exterior member 11 has a relatively larger amount of the glass component 12 than the inner region, preferably the inner half (or the lower half) of the exterior member 11 as illustrated in FIG. 2, for example. Such a configuration can also prevent or suppress entry of water vapor or moisture into the battery main body. Not only such gas barrier properties but also strength, impact resistance, airtightness, moisture resistance and the like of the exterior member 11 can be enhanced. Hereinafter, the “exterior member” and the “pore”, the “glass component”, and the like included therein will be described in more detail.

(Exterior Member)

In the present disclosure, the “exterior member” means a covering layer or an exterior layer that can preferably wholly cover the battery main body (for example, the solid state battery laminate 10 illustrated in FIG. 1) of the solid state battery and includes, for example, the “glass component” described in detail below as a base material or a matrix. Such an exterior member is preferably formed of a sintered body containing a glass component or the like.

In the present disclosure, the term “glass component” means a composition or material containing glass as a main component (hereinafter, also referred to as “glass material” in some cases). The glass material is not particularly limited, and examples thereof include at least one selected from the group consisting of silica glass (glass containing silicon oxide, silicon oxynitride, or the like as a main component), soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass.

In the present disclosure, the term “pore” means one or more spaces, intervals, gaps, or cavities that can be formed inside an exterior member (particularly, a glass material).

The exterior member (particularly, a glass material) has generally airtightness but is hard and brittle.

However, by forming pores on the inner side of the exterior member (particularly, a glass material) as in the present disclosure, it is possible to significantly suppress the occurrence of cracking, chipping, or the like while securing the gas barrier properties in the exterior member.

The shape of the pore is not particularly limited, in other words, the pore may have any shape, and the shape of the pore may be geometric, regular, or irregular. For example, as illustrated in FIG. 2, the sectional surface may be a spherical shape having a substantially circular shape, or the sectional surface may have a shape such as an elliptical shape, a rugby ball shape, a substantially triangular shape, a substantially quadrangular shape, a substantially polygonal shape, a substantially cross shape, and/or a substantially star shape, or a random shape (see FIG. 9). Therefore, pores having a plurality of different shapes and dimensions may be randomly mixed in the exterior member (particularly, a glass material).

The shape of the pore is ideally a spherical shape having a circular sectional surface. It is preferable to have a shape close to a spherical shape having a circular sectional surface. From such a viewpoint, the circularity may be within a range of 0.1 to 1.0.

The dimension of the pore is not particularly limited, and for example, as illustrated in FIG. 2, when the shape of the sectional surface is substantially circular, the diameter or the maximum diameter thereof may be the dimension of the pore, and when the pore has a sectional surface of another shape, the diameter calculated by converting the sectional surface into a circular shape may be the dimension of the pore.

The dimension of the pore is, for example, within a range of 1 μm to 20 μm. The average dimension of pores that can be included in the exterior member (particularly, a glass material) is, for example, in a range of 3 μm to 20 μm.

The dimension of such a pore can be determined by image processing such as binarization from an electron micrograph of a sectional surface of the exterior member. The binarization will be described in detail below.

(Sectional Surface)

More specifically, the sectional surface of the exterior member can be formed by the following method.

For example, the solid state battery is solidified with a resin, and then cut to the vicinity of the observation surface. The cut surface is subjected to planarization of the observation surface using abrasive paper or the like.

The polishing method is not particularly limited, but rough cutting can be performed using coarse polishing paper, and then polishing can be performed using polishing paper having a small abrasive grain size or a polishing agent. For the polishing, an automatic polishing machine, polishing paper, ion milling, or chemical mechanical polishing (CMP) may be used. The polished surface subjected to planarization is imaged with an electron microscope and binarized using image processing software, and the porosity and/or the dimension of the pore can be calculated.

The cut surface in the sectional observation of the exterior member may be processed with any surface as the bottom surface, but is preferably processed perpendicular to the bottom surface.

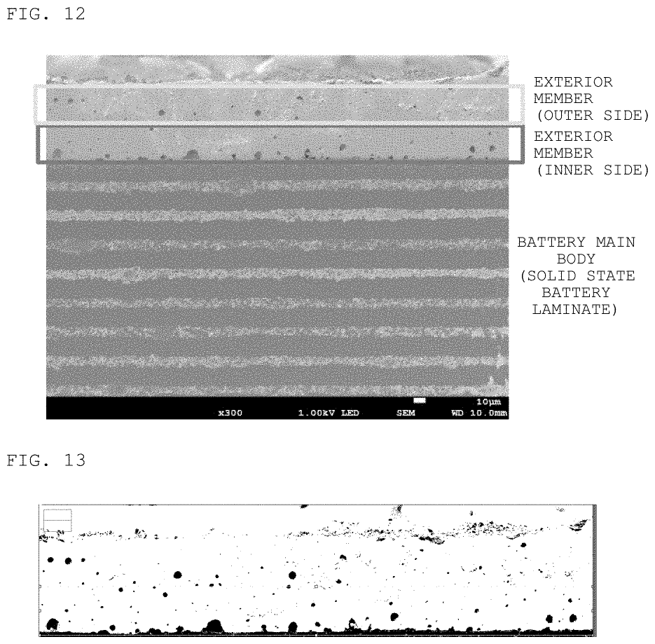

Processing may be performed at a half position with respect to the depth with the surface to be cut on the front side (see, for example, FIG. 10).

There is no limitation on how to obtain a section, but it is preferable that the sectional surface is smooth, and for example, a smooth observed sectional surface can be obtained by embedding the solid state battery in a cured resin, performing polishing to obtain a section, and then processing by ion milling.

(Pore)

The pore can be formed, for example, by using a pore forming agent or the like when the exterior member is formed, or by intentionally reducing the amount of the glass component.

Such pores may include pores that can be formed as bubbles inside the exterior member by a gas (for example, O₂, CO₂, CO, or the like) that can be generated at the time of firing when the exterior member is formed by integral firing together with the layers that can be included in the battery main body (that is, when the battery main body is formed as an integrally sintered body).

As the pore forming agent, for example, an organic substance may be used, and for example, a polymer (a polymer such as polyolefin, such as polyethylene and/or polypropylene, although it is merely an example) may be used. For example, an organic substance (for example, a polymer such as polypropylene) such as a binder may be vaporized at the time of firing to form bubbles, and furthermore, pores inside the exterior member.

For example, in the exterior member 11 illustrated in FIG. 2, the pore 13 may be present on the inner side (or lower side) of the exterior member 11 adjacent to the battery main body (or an interface). In other words, the pore 13 may be present in an inner region of the exterior member 11 adjacent to the battery main body (or an interface), preferably the inner half (or the lower half) or the exterior member 11. The pore 13 may be in contact with an interface between the exterior member 11 and the battery main body. The sectional shape of the pore is not necessarily limited to a circular shape.

More specifically, as schematically illustrated in FIG. 2, the pores 13 are preferably present in a region in the thickness direction indicated by the height H₁ of 50% or less, preferably 35% or less with respect to a height H₀ in the thickness direction of the exterior member 11.

In the solid state battery of the present disclosure, it is preferable that the inner region of the exterior member 11 adjacent to the battery main body (or an interface), preferably the inner half (or the lower half) of the exterior member 11 has a larger porosity than the outer half (or the upper half), or the number of pores 13 is relatively large. In other words, in the exterior member 11, it is preferable that the pores 13 are unevenly distributed in the region in the thickness direction indicated by the height H₁ of 50% or less with respect to the height H₀ in the thickness direction of the exterior member 11. Therefore, in the solid state battery of the present disclosure, the pore 13 may be present in the outer region, preferably the outer half (or the upper half), of the exterior member 11, but it is preferable that the number, area, or volume of the pores 13 present in the inner region, preferably the inner half (or the lower half), is larger than the number, area, or volume of the pores present in the outer region.

The height H₀ in the thickness direction of the exterior member 11 is, for example, 500 μm or less.

As described above, inside the exterior member 11, a larger number of pores are present in the inner region adjacent to the battery main body (or an interface), so that the expansion and contraction of the battery main body can be further alleviated, and cracking or chipping can be suppressed, and the gas barrier properties can be further improved.

Inside the exterior member 11, the pores 13 may be unevenly distributed in a region indicated by a length L₁ of, for example, less than 100%, preferably 90% or less with respect to a length L₀ of the exterior member 11 (for example, a length in a direction perpendicular to the stacking direction of the solid state battery laminate) (that is, from both ends of the exterior member 11).

The pore 13 may be present at a ratio of, for example, 2% to 20%, preferably 3% to 15% with respect to the total area of the exterior member 11 in a sectional view. Such a ratio can be determined by image processing such as binarization from an electron micrograph of a sectional surface of the exterior member.

In the solid state battery of the present disclosure, the exterior member may be preferably a water vapor barrier film. That is, the exterior member covers the top surface, the bottom surface, and the front and back surfaces of the solid state battery so as to be preferably provided as a barrier that blocks the entry of moisture into the solid state battery. The “barrier” in the present specification broadly means having a characteristic of blocking the water-vapor transmission in order not to allow water vapor in the external environment to permeate the exterior member and thus in order not to cause degradation of characteristics that is inconvenient to the solid state battery, and narrowly means having a water vapor transmission rate of less than 1.0×10⁻³ g/(m²·Day). Hence, in short, it can be said that the water vapor barrier film preferably has a water vapor transmission rate of 0 to less than 1.0×10⁻³ g/(m²·Day). The term “water vapor transmission rate” as used herein refers to the transmission rate acquired using the gas transmission rate measuring instrument of model GTms-1 manufactured by ADVANCE RIKO, Inc. under the measurement conditions of 40° C., 90% RH, and a differential pressure of 1 atm.

In particular, in the case of a NaSICON-type structure, the solid state battery preferably has a water vapor transmission rate of less than 1.0×10⁻³ g/(m²·Day).

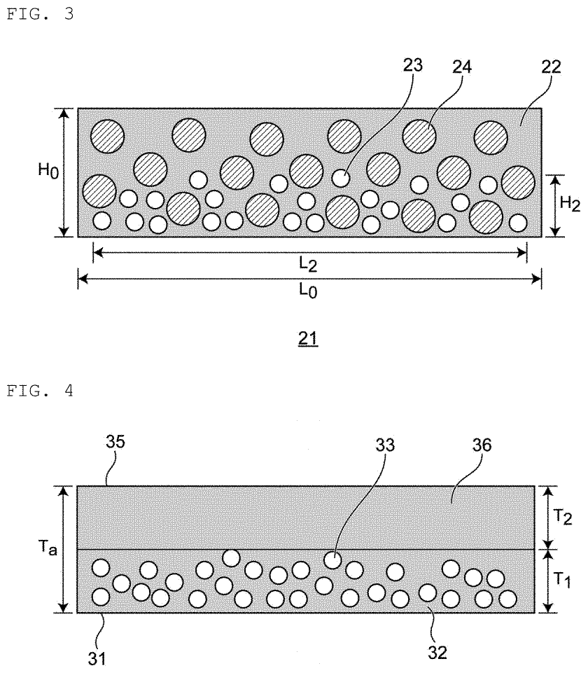

The exterior member 11, particularly the glass component 12, may further contain an inorganic filler 24, for example, as illustrated in FIG. 3.

The inorganic filler 24 is not particularly limited, and examples thereof include at least one selected from the group consisting of various ceramics, for example, oxides such as alumina, silica, and zirconia, nitrides, carbides, and the like. By adding such an inorganic filler, for example, strength, impact resistance, airtightness, and/or moisture resistance, etc. can be further improved.

The inorganic filler 24 may be unevenly distributed or may not be unevenly distributed in an exterior member 21. The inorganic filler 24 may be uniformly dispersed. The inorganic filler 24 is present at a ratio of, for example, 10% to 90% with respect to the total area of the exterior member 21 in a sectional view. Such a ratio can be determined by image processing such as binarization from an electron micrograph of a sectional surface of the exterior member.

The exterior member 21, the glass component 22, the pore 23, and a height H₂ and a length L₂ in the thickness direction illustrated in FIG. 3 can correspond to the exterior member 11, the glass component 12, the pore 13, and the height H₁ and the length L₁ in the thickness direction illustrated in FIG. 2, respectively.

In the solid state battery of the present disclosure, the exterior member may have, for example, a “two-layer structure” including a “first exterior member” and a “second exterior member”, or may have a structure of two or more layers (for example, an intermediate layer or mixed layer that can be formed during manufacturing, a third exterior member, a fourth exterior member, a fifth exterior member, . . . , and the like).

In one aspect, in the solid state battery of the present disclosure, the exterior member preferably has a structure of two or more layers.

For example, in an embodiment illustrated in FIG. 4, the exterior member (for example, the exterior member 11 illustrated in FIG. 2) may have a form in which the exterior member is separated into two layers of a first exterior member 31 and a second exterior member 35.

In the embodiment illustrated in FIG. 4, for example, the solid state battery laminate 10 illustrated in FIG. 1, that is, the battery main body can be disposed below the first exterior member 31.

In the embodiment illustrated in FIG. 4, it is preferable that the first exterior member 31 is provided adjacent to the battery main body (or an interface), the second exterior member 35 is provided adjacent to the first exterior member 31 on a side opposite to the battery main body, and a pore 33 is present in the first exterior member 31. In the solid state battery of the present disclosure, a pore may be present in the second exterior member 35, but the number, area, or volume of the pores is preferably smaller than the number, area, or volume of the pores 33 included in the first exterior member 31.

It is preferable that the first exterior member 31 and the second exterior member 35 each independently contain a glass component (or a glass material) (32, 36), and a pore 33 is present in the glass component 32 of the first exterior member 31. The pore 33 included in the first exterior member 31 (specifically, the glass component 32) can correspond to the pore 13 in FIG. 2, and the glass components described above can also be used independently for the glass components (32, 36) that can be contained in the first exterior member 31 and the second exterior member 35 (hereinafter, the glass component that can be contained in the first exterior member 31 is referred to as “first glass component 32”, and the glass component that can be contained in the second exterior member 35 is referred to as “second glass component 36”).

In the first exterior member 31 illustrated in FIG. 4, the first glass component 32 is preferably present at a ratio of, for example, 10% to 60% with respect to the total area of the first exterior member 31 in a sectional view.

In the embodiment illustrated in FIG. 4, a thickness T₁ of the first exterior member 31 is preferably 50% or less with respect to the total thickness Tₐ of the exterior member (“the thickness T₁” of the first exterior member 31”+“the thickness T₂ of the second exterior member 35”).

In the second exterior member 35 illustrated in FIG. 4, the second glass component 36 is preferably present at a ratio of, for example, 100% or less, preferably 30% to 80% with respect to the total area of the second exterior member 35 in a sectional view.

In the embodiment illustrated in FIG. 4, the thickness T₂ of the second exterior member 35 is preferably larger than 50% with respect to the total thickness Tₐ of the exterior member.

The first exterior member 31 and the second exterior member 35 may each independently further contain the inorganic filler described above.

Each of the first exterior member 31 and the second exterior member 35 may contain the inorganic filler.

Alternatively, either one of the first exterior member 31 and the second exterior member 35 may contain the inorganic filler.

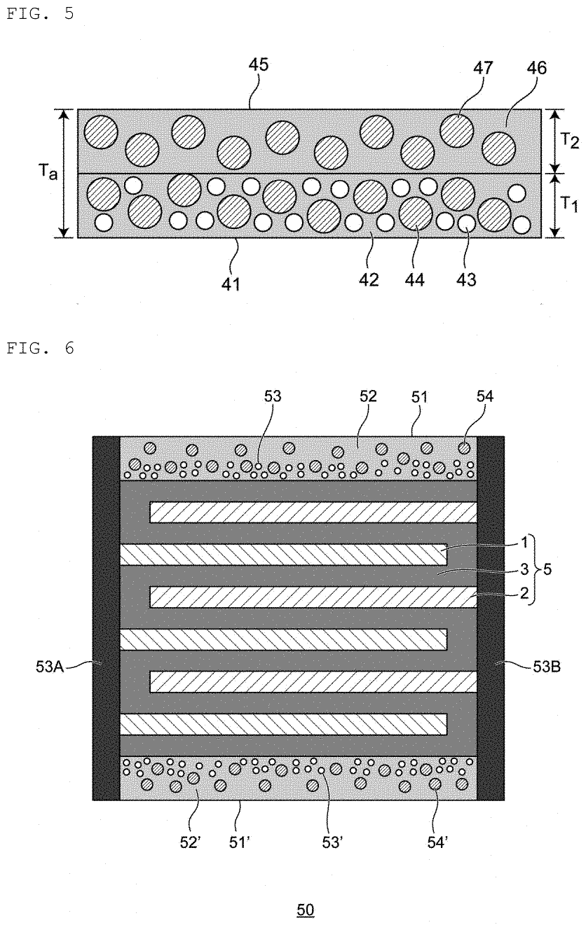

For example, in an embodiment illustrated in FIG. 5, a first exterior member 41 may contain a first inorganic filler 44, and a second exterior member 45 may contain a second inorganic filler 47. The first inorganic filler 44 that can be contained in the first exterior member 41 and the second inorganic filler 47 that can be contained in the second exterior member 45 may be the same as or different from each other.

In the embodiment illustrated in FIG. 5, a first glass component 42 and pores 43 that can be contained in the first exterior member 41 can correspond to the first glass component 32 and the pores 33 that can be contained in the first exterior member 31 illustrated in FIG. 4, respectively. A second glass component 46 that can be contained in the second exterior member 45 illustrated in FIG. 5 can correspond to the second glass component 36 illustrated in FIG. 4.

In the embodiment illustrated in FIG. 5, the ratio of the first glass component 42 in the first exterior member 41 is preferably 20% or less with respect to total volume of the first exterior member 41. When the glass component is present at such a ratio, a more sufficient amount of the pore 43 can be secured in the first exterior member 41. Therefore, at the time of charging and discharging the solid state battery, the stress that may be generated by volume expansion or contraction of the battery main body can be alleviated by the plurality of pores 43 as a cushion, and furthermore, cracking or chipping of the first exterior member 41 can be suppressed or prevented. As a result, entry of water vapor or moisture into the battery main body can be suppressed or prevented.

In the embodiment illustrated in FIG. 5, the ratio of the second glass component 46 in the second exterior member 45 is preferably 50% or more with respect to total volume of the second exterior member 45. When the glass component is present at such a ratio, a more sufficient amount of the glass component can be secured in the second exterior member 45. Therefore, in the second exterior member 45, strength, impact resistance, airtightness, and/or moisture resistance, etc. can be improved.

For example, as illustrated in FIG. 5, by dividing the exterior member into at least two layers of the first exterior member 41 and the second exterior member 45, the role of each layer can be clarified. Therefore, in the solid state battery of the present disclosure, the exterior member preferably has a two-layer structure or a structure of two or more layers.

In the exterior member of the present disclosure, when the exterior member has a structure of two or more layers, the boundary may be not necessarily linear. Depending on the type of the selected glass component, for example, by using the same glass component, the boundary may not be confirmed visually or with a microscope or the like.

In the solid state battery of the present disclosure, when the exterior member is a sintered body, a boundary between the glass component and the inorganic filler may not be confirmed visually or with a microscope or the like depending on the selected material, for example, by using ceramic or the like as the inorganic filler.

### Certain Preferred Embodiment

A preferred embodiment of the solid state battery of the present disclosure is illustrated in FIG. 6 as “solid state battery 50” although it is merely one example. The solid state battery 50 may include, for example, a solid state battery laminate (that is, a battery main body) including at least one battery constituent unit 5, for example, along a stacking direction, the at least one battery constituent unit 5 including a positive electrode layer 1, a negative electrode layer 2, and a solid electrolyte layer 3 interposed therebetween, as illustrated in FIG. 1. As the external terminal 53, for example, the positive electrode terminal 53A and the negative electrode terminal 53B may be provided on the right and left side surfaces (or end surfaces) facing each other of such a battery main body so that the positive electrode terminal and the negative electrode terminal face each other. The solid state battery 50 includes an exterior member (51, 51′) covering the battery main body.

More specifically, the solid state battery 50 includes exterior members (51, 51′) covering the periphery (upper and lower surfaces and front and rear surfaces) of the battery main body except for right and left side surfaces (or end surfaces). In the sectional view illustrated in FIG. 6, for example, the exterior members 21 as illustrated in FIG. 3 are disposed above and below the battery main body so as to face each other vertically (see, for example, exterior members (51, 51′) illustrated in FIG. 6). In the embodiment illustrated in the drawing, the external terminals (53A, 53B) are also disposed on the right and left side surfaces (or end surfaces) of the exterior member (51, 51′), but the right and left side surfaces of the exterior member (51, 51′) may be covered with or not covered with such external terminals.

A pore (53, 53′) may be present on a side (for example, an inner region, preferably, inner half) adjacent to the battery main body (or an interface) on the inner side of the exterior member (51, 51′) that can cover the battery main body. Therefore, the stress that may be generated by volume expansion or contraction of the battery main body at the time of charging and discharging such a solid state battery can be alleviated by such pores (53, 53′), and furthermore, cracking or charging of the exterior member (51, 51′) can be suppressed or prevented. As a result, entry of water vapor or moisture into the battery main body can be suppressed or prevented.

In the outer region, preferably the outer half of the exterior member (51, 51′), the ratio of the glass component (52, 52′) becomes larger. Therefore, in the exterior member (51, 51′), the gas barrier properties against water vapor and the like can be further improved.

Since the inorganic filler (54, 54′) can be contained inside the exterior member (51, 51′) covering the battery main body, the strength, impact resistance, airtightness, and/or moisture resistance, etc. can also be further improved in the exterior member (51, 51′).

In the solid state battery 50, the exterior member (51, 51′) may be appropriately changed to the exterior member 11 illustrated in FIG. 2.

Another preferred embodiment of the solid state battery of the present disclosure is illustrated in FIG. 7 as “solid state battery 60”. The solid state battery 60 may include, for example, a solid state battery laminate (that is, a battery main body) including at least one battery constituent unit 5, for example, along a stacking direction, the at least one battery constituent unit 5 including a positive electrode layer 1, a negative electrode layer 2, and a solid electrolyte layer 3 interposed therebetween, as illustrated in FIG. 1. As the external terminal 63, the positive electrode terminal 63A and the negative electrode terminal 63B may be provided on the right and left side surfaces (or end surfaces) facing each other of such a battery main body so that the positive electrode terminal and the negative electrode terminal face each other. The solid state battery 60 includes a first exterior member (61, 61′) and a second exterior member (65, 65′) as an exterior member having a two-layer structure covering the battery main body.

More specifically, the solid state battery 60 may include the first exterior member (61, 61′) and the second exterior member (65, 65′) covering the periphery (upper and lower surfaces and front and rear surfaces) of the battery main body except for right and left side surfaces (or end surfaces). In the sectional view illustrated in FIG. 7, the first exterior member (61, 61′) and the second exterior member (65, 65′) are disposed as a two-layer structure (see FIG. 5) above and below the battery main body so as to face each other vertically. In the embodiment illustrated in the drawing, the external terminals (63A, 63B) are also disposed on the right and left side surfaces (or end surfaces) of the first exterior member (61, 61′) and the second exterior member (65, 65′), but the right and left side surfaces of the first exterior member (61, 61′) and the second exterior member (65, 65′) may be covered with or not covered with such external terminals.

A pore (63, 63′) may be present in the first exterior member (61, 61′) directly covering the battery main body. Therefore, the stress that may be generated by volume expansion or contraction of the battery main body at the time of charging and discharging such a solid state battery can be alleviated by such pores (63, 63′), and furthermore, cracking or charging of the first exterior member (61, 61′) can be suppressed or prevented. As a result, entry of water vapor or moisture into the battery main body can be suppressed or prevented.

In the second exterior member (65, 65′), the ratio of the glass component (66, 66′) becomes larger than that of the first exterior member (61, 61′). Therefore, in the second exterior member (65, 65′), the gas barrier properties against water vapor and the like can be further improved.

Since the first inorganic filler (64, 64′) and the second inorganic filler (67, 67′) can be contained in the first exterior member (61, 61′) and the second exterior member (65, 65′) covering the battery main body, respectively, strength, impact resistance, airtightness, and/or moisture resistance, etc. can be further improved in the first exterior member (61, 61′) and the second exterior member (65, 65′), particularly the second exterior member (65, 65′).

In the solid state battery 60, the first exterior member (61, 61′) and the second exterior member (65, 65′) may be appropriately changed to the first exterior member 31 and the second exterior member 35 illustrated in FIG. 4.

In the above embodiment, since a heat insulating effect can be expected due to the pore that can be included in the exterior member in any form, the solid state battery can be used under a wide range of temperatures. For example, the solid state battery of the present disclosure can also withstand mounting of the solid state battery on a substrate by reflow solder or the like. Therefore, the solid state battery of the present disclosure can be used as a chip-type surface mount device (SMD).

In the above embodiment, the positive electrode layer 1 and the negative electrode layer 2 are preferably layers capable of occluding and releasing lithium ions. With such a configuration, the secondary battery of the present disclosure can be used as a lithium ion secondary battery.

The solid state battery of the present disclosure is not limited to the above embodiments. As described above, the solid state battery of the present disclosure can be manufactured, for example, by a printing method such as a screen printing method, which is conventionally known, a green sheet method using a green sheet, or a method combining these methods. However, the method for manufacturing a solid state battery of the present disclosure is not limited to the following production method.

(Binarization)

The binarization can be performed using, for example, “Fiji imageJ” (https://imagej.net/Fiji) which is image processing software in an open source and public domain.

For example, a photograph of a sectional surface taken with an electron microscope as shown in FIG. 11 is binarized using image processing software “Fiji imageJ” to calculate a porosity or the like.

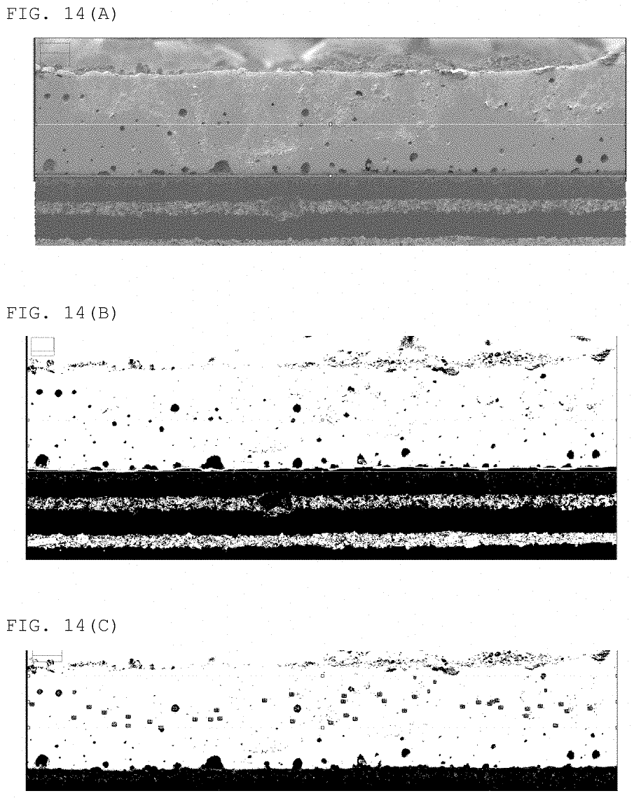

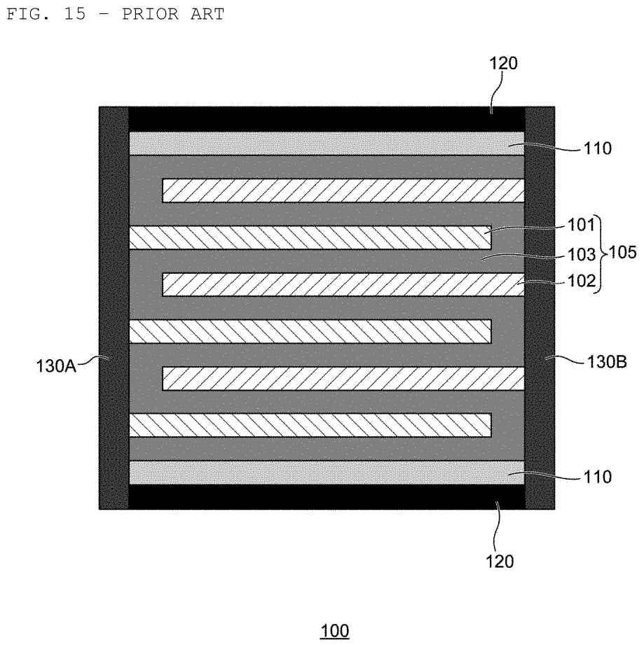

The porosity of each of the “exterior member (outer side)” and the “exterior member (inner side)” can be binarized by being divided into the “exterior member (outer side)” and the “exterior member (inner side)”, for example, as shown in FIG. 12.

Conditions of the binarization are not particularly limited as long as pores can be recognized. For example, in image processing software “Fiji imageJ”, the binarization can be performed by auto (“Auto”) of default (“Default”) (see FIG. 13).

When a boundary between the “exterior member (inner side)” and the “battery main body (or the solid state battery laminate)” is not clear (see, for example, FIG. 14(A)), for example, the boundary may be clarified by a line such as a white line using a drawing function (see FIG. 14(B)). For example, the thickness of the line such as a white line may be set to the number of pixels of 1 μm or less. Such a line such as a white line can be interpreted as being included in the “exterior member (inner side)” in the present disclosure.

See FIG. 14(C) for the binarization of the “exterior member (outer side)”.

It is preferable to acquire images in advance so that the objects are parallel along the horizontal direction so that the images can be properly analyzed in the image analysis after binarization.

The range is set such that all the exterior members (outer sides) are included so that all the pores can be recognized in the exterior member (inner side), and the range is set such that the analysis areas of the “exterior member (outer side)” and the “exterior member (inner side)” are the same.

For example, in order to make the area of the “exterior member (outer side) and the area of the “exterior member (inner side)” the same, for example, the thickness of the exterior member is measured in advance, and when the range is designated as a guide, the analysis range can be appropriately determined with reference to, for example, the length shown in the window of “image)”.

The “porosity (%)” (or the pore area ratio (%)) can be determined by measuring the area of pores in a designated range. Specifically, the porosity (%) may be determined by selecting “Analyze particles”.

For example, it is preferable to determine the porosity within a range of an area (size) of pores of 0.785 to 400 μm² (corresponding to circle diameter (“Circularity”) of 1 to 20 μm) and circularity of 0.1 to 1.0. From these values, the sectional surface of the pore can be converted into a circle to determine the diameter and the like.

In the samples shown in FIG. 11 to FIG. 14, the porosity of the “exterior member (inner side)” was “3.793%”, and the porosity of the “exterior member (outer side)” was “1.511%”.

By such binarization, the ratio of “the porosity of the exterior member (inner side)”/“the porosity of the exterior member (outer side)” can be determined.

The ratio of “the porosity of the exterior member (inner side)”/“the porosity of the exterior member (outer side)” is, for example, larger than 1.0, preferably 1.1 or more, and more preferably 2 to 10. The upper limit value of the ratio may be, for example, 10, 9, 8, 7, 6, 5, 4, 3, or the like.

For example, in the samples shown in FIG. 11 to FIG. 14, the ratio of “the porosity of the exterior member (inner side)”/“the porosity of the exterior member (outer side)” was “2.5”.

In the exterior member (inner side), the pore may be present at a ratio of, for example, 2% to 20%, preferably 4% to 20% with respect to the total area of the exterior member (inner side) in a sectional view (see FIG. 4).

In the exterior member (outer side), when the exterior member (outer side) includes a pore, such a pore may be present at a ratio, for example, 2% to 20%, preferably 2% to 10% with respect to the total area of the exterior member (outer side) in a sectional view (see FIG. 4).

Hereinafter, the solid state battery of the present disclosure will be described in more detail with reference to Examples. The solid state battery of the present disclosure is not limited to the description of the following Examples.

### EXAMPLES

### Example 1

The solid state battery 60 of the embodiment illustrated in FIG. 7 was produced.

Preparation of Solid State Battery Laminate

The solid state battery laminate can be manufactured by a printing method such as a screen printing method, a green sheet method using a green sheet, or a composite method thereof. That is, the solid state battery laminate may be produced according to a conventional solid state battery manufacturing method (thus, as raw material substances such as a solid electrolyte, an organic binder, a solvent, an optional additive, a positive electrode active material, and a negative electrode active material described below, those used in the manufacturing of known solid state batteries may be used).

(Laminate Block Formation)

A solid electrolyte, an organic binder, a solvent, and an arbitrary additive were mixed to prepare a slurry. Subsequently, a sheet having a thickness of about 10 μm after firing was obtained from the prepared slurry by sheet molding.

A positive electrode active material, a solid electrolyte, a conduction aid, an organic binder, a solvent, and an arbitrary additive were mixed to prepare a positive electrode paste. Similarly, a negative electrode active material, a solid electrolyte, a conduction aid, an organic binder, a solvent, and an optional additive were mixed to prepare a negative electrode paste.

The positive electrode paste was printed on the sheet, and a current collecting layer was printed as necessary. Similarly, the negative electrode paste was printed on the sheet, and a current collecting layer was printed as necessary.

The sheet on which the positive electrode paste was printed and the sheet on which the negative electrode paste was printed were alternately stacked to obtain a laminate.

The outermost layer (the uppermost layer and/or the lowermost layer) of the laminate may be the electrolyte layer, an insulating layer, or the electrode layer.

(Battery Sintered Body Formation)

After the laminate was pressure-bonded and integrated, the laminate was cut into a predetermined size. The resulting cut laminate was subjected to degreasing and firing. Thus, a sintered laminate was obtained.

The laminate may be subjected to degreasing and firing before cutting, and then cut.

(ii) Formation of External Terminal

For example, as illustrated in FIG. 7, a silver (Ag) paste was applied onto the entire surface of at least the left side surface (end surface) and the entire surface of the right side surface (end surface) of the solid state battery laminate, and was heated and cured on a hot plate at 200° C. for 30 minutes to form an external terminal formed of silver (Ag) (the positive electrode terminal 63A, the negative electrode terminal 63B).

(iii) Formation of Characteristic Part (Exterior Member) of the Present Invention

A paste for the first exterior member and a paste for the second exterior member were prepared as follows.

The paste for the first exterior member and the paste for the second exterior member were stacked as green sheets in a two-layer structure around the block except for the side surface on which the external terminal of the unfired laminate block was formed, and integrally fired together with the solid state battery laminate as described above.

Paste for First Exterior Member

A paste containing a glass material, an inorganic filler, an organic binder, and a solvent was prepared.

In the paste for the first exterior member, the ratio of the glass material and the inorganic filler was adjusted so that the volume ratio of the glass component/the inorganic filler contained in the first exterior member (61, 61′) after firing was 20/80.

Paste for Second Exterior Member

A paste containing a glass material, an inorganic filler, an organic binder, and a solvent was prepared.

In the paste for the second exterior member, the ratio of the glass material and the inorganic filler was adjusted so that the volume ratio of the glass component/the inorganic filler contained in the second exterior member (65, 65′) after firing was 50/50.

In the solid state battery 60 of Example 1, the pores (63, 63′) included in the first exterior member (61, 61′) were formed by a gas (O₂, CO₂, CO, or the like) generated from each layer of the laminate block during integral sintering with the solid state battery laminate.

### Example 2

A solid state battery was produced in the same manner as in Example 1, except that no inorganic filler was used in the pastes for the first and second exterior members and the number of layers of the solid state battery laminate was increased.

The solid state battery was solidified with a resin, and then cut to the vicinity of the observation surface (see FIG. 10). The cut surface was subjected to planarization of the observation surface using abrasive paper.

Specifically, the solid state battery was embedded in a cured resin, then polished to expose a sectional surface, and then processed by ion milling to form a smooth observed sectional surface.

The sectional surface of the solid state battery was imaged with an electron microscope (SEM) (see FIG. 11 (scale bar: 10 μm)), and binarized using image processing software (“Fiji imageJ” (https://imagej.net/Fiji)) (see FIG. 14).

(Binarization)

The distance per pixel (“Distance in pixels”) was normalized from the length of the scale bar of the electron micrographs (10 μm) ((“Known Distance”) and the measurement unit (micrometer (μm)) (“Unit of Length”).

The distance per pixel (“Distance in pixels”) was “33” (“Pixel aspect ratio”=1.0).

The exterior member was binarized by being divided into “exterior member (outer side)” and the “exterior member (inner side)” (see FIG. 12).

In image processing software “Fiji imageJ”, the binarization was performed using auto (“Auto”) of default (“Default”) (see FIG. 13 and FIG. 14).

The boundary between the “exterior member (inner side)” and the “battery main body (or the solid state battery laminate)” was clarified by a white line (the number of pixels of 1 μm or less) (see FIG. 14(B)). Such a white line is interpreted as being included in the “exterior member (inner side)”.

See FIG. 14(C) for the binarization of the “exterior member (outer side)”.

The range of the image analysis was set such that the analysis area of the “exterior member (outer side)” and the analysis area of the “exterior member (inner side)” were the same.

The “porosity (%)” (or the pore area ratio (%)) was determined by measuring the area of pores in a designated range (within a range of an area of pores of 0.785 to 400 μm² (corresponding to circle diameter (“Circularity”) of 1 to 20 μm) and circularity of 0.1 to 1.0).

The porosity of the “exterior member (inner side)” was “3.793%”, and the porosity of the “exterior member (outer side)” was “1.511%”.

The ratio of “the porosity of the exterior member (inner side)”/“the porosity of the exterior member (outer side)” was “2.5”.

From the above, in the solid state battery produced in Example 2, it was verified that “the porosity of the exterior member (outer side)” is larger than “the porosity of the exterior member (inner side)”.

Hereinbefore, the solid state battery of the present disclosure has been described with reference to various embodiments and examples; however, these are merely typical examples. Accordingly, the present disclosure is not limited thereto, and those skilled in the art will readily understand that various aspects are conceivable.

(Aspect 1)

A solid state battery that includes: a solid state battery laminate including at least one battery constituent unit, the at least one battery constituent unit including a positive electrode layer, a negative electrode layer, and a solid electrolyte layer interposed between the positive electrode layer and the negative electrode layer; a first external terminal on a first side surface of the solid state battery laminate; a second external terminal on a second side surface of the solid state battery laminate, the second side surface facing the first side surface across the solid state battery laminate; and an exterior member covering the solid state battery laminate, the exterior member including one or more pores on an inner side of the exterior member adjacent to the solid state battery laminate.

(Aspect 2)

The solid state battery described in aspect 1, in which the one or more pores are present at a ratio of 2% to 20% with respect to a total area of the exterior member in a sectional view thereof.

(Aspect 3)

The solid state battery described in aspect 1 or 2, in which the one or more pores are present in an inner region of the exterior member adjacent to the solid state battery laminate (or an interface).

(Aspect 4)

The solid state battery described in aspect 3, in which the inner region of the exterior member adjacent to the solid state battery laminate (or an interface) has a larger porosity than a porosity of an outer region further from the solid state battery laminate than the inner region.

(Aspect 5)

The solid state battery described in any one of aspects 1 to 4, in which the exterior member contains a glass component, and the one or more pores are present in the glass component.

(Aspect 6)

The solid state battery described in aspect 5, in which the exterior member further contains an inorganic filler.

(Aspect 7)

A solid state battery that includes: a solid state battery laminate including at least one battery constituent unit, the at least one battery constituent unit including a positive electrode layer, a negative electrode layer, and a solid electrolyte layer interposed between the positive electrode layer and the negative electrode layer; a first external terminal on a first side surface of the solid state battery laminate; a second external terminal on a second side surface of the solid state battery laminate, the second side surface facing the first side surface across the solid state battery laminate; and an exterior member covering the solid state battery laminate, wherein the exterior member includes at least a first exterior member layer and a second exterior member layer, the first exterior member layer located adjacent to the solid state battery laminate and including one or more pores, the second exterior member layer located adjacent to a side of the first exterior member layer opposite to the solid state battery laminate.

(Aspect 8)

The solid state battery described in aspect 7, in which the one or more pores are present at a ratio of 2% to 20% with respect to a total area of the first exterior member layer in a sectional view thereof.

(Aspect 9)

The solid state battery described in aspect 7 or 8, in which the second exterior member layer also includes one or more pores, a ratio of a porosity of the first exterior member layer with respect to a total area of the first exterior member layer/a porosity of the second exterior member layer with respect to a total area of the second exterior member layer in a sectional view thereof is 1.1 or more.

(Aspect 10)

The solid state battery described in aspect 7, in which the exterior member has a structure of two or more layers.

(Aspect 11)

The solid state battery described in aspect 7, in which each of the first exterior member layer and the second exterior member layer contains a glass component, and the one or more pores are present in the glass component of the first exterior member layer.

(Aspect 12)

The solid state battery described in aspect 5 or 11, in which the glass component is at least one selected from the group consisting of silica glass, soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass.

(Aspect 13)

The solid state battery described in aspect 11 or 12, in which the first exterior member layer and/or the second exterior member layer further contains an inorganic filler.

(Aspect 14)

The solid state battery described in aspect 11 or 12, in which either one of the first exterior member layer and the second exterior member layer contains an inorganic filler.

(Aspect 15)

The solid state battery described in any one of aspects 1 to 14, in which the exterior member has a water vapor transmission rate of less than 1.0×10⁻³ g/(m²·Day).

(Aspect 16)

The solid state battery described in any one of aspects 1 to 15, in which the positive electrode layer and the negative electrode layer are layers capable of occluding and releasing lithium ions.

The solid state battery of the present invention can be used in various fields where battery use or power storage can be assumed. Although it is merely an example, the solid state battery of the present invention can be used in the fields of electricity, information, and communication (for example, electric and electronic equipment fields or mobile equipment fields including mobile phones, smartphones, notebook computers and digital cameras, activity meters, arm computers, electronic paper, wearable devices, RFID tags, card-type electronic money, small electronic machines such as smartwatches, and the like.) in which electricity, electronic equipment, and the like are used, home and small industrial applications (for example, the fields of electric tools, golf carts, and home, nursing, and industrial robots), large industrial applications (for example, fields of forklift, elevator, and harbor crane), transportation system fields (field of, for example, hybrid automobiles, electric automobiles, buses, trains, power-assisted bicycles, and electric two-wheeled vehicles), power system applications (for example, fields such as various types of power generation, road conditioners, smart grids, and household power storage systems), medical applications (medical equipment fields such as earphone hearing aids), pharmaceutical applications (fields such as dosage management systems), IoT fields, space and deep sea applications (for example, fields such as a space probe and a submersible.), and the like.

### DESCRIPTION OF REFERENCE SYMBOLS

1, 101: Positive electrode layer
2, 102: Negative electrode layer
3, 103: Solid electrolyte layer (or solid electrolyte)
5, 105: Battery constituent unit
10: Solid state battery laminate (or battery main body)
11, 21, 51: Exterior member
12, 22, 52: Glass component
13, 23, 33, 43, 53, 63: Pore
24, 54: Inorganic filler
31, 41, 61: First exterior member
32, 42, 62: First glass component
35, 45, 65: Second exterior member
36, 46, 66: Second glass component
44, 64: First inorganic filler
47, 67: Second inorganic filler
50, 60: Solid state battery
100: Conventional solid state battery
110: Waterproof layer
120: Resin layer
53, 63, 130: External terminal
53A, 63A, 130A: Positive electrode terminal
53B, 63B, 130B: Negative electrode terminal

1. A solid state battery comprising:
a solid state battery laminate including at least one battery constituent unit, the at least one battery constituent unit including a positive electrode layer, a negative electrode layer, and a solid electrolyte layer interposed between the positive electrode layer and the negative electrode layer;
a first external terminal on a first side surface of the solid state battery laminate;
a second external terminal on a second side surface of the solid state battery laminate, the second side surface facing the first side surface across the solid state battery laminate; and
an exterior member covering the solid state battery laminate, the exterior member including one or more pores on an inner side of the exterior member adjacent to the solid state battery laminate.

2. The solid state battery according to claim 1, wherein the one or more pores are present at a ratio of 2% to 20% with respect to a total area of the exterior member in a sectional view thereof.

3. The solid state battery according to claim 1, wherein the one or more pores are present in an inner region of the exterior member adjacent to the solid state battery laminate.

4. The solid state battery according to claim 3, wherein the inner region of the exterior member adjacent to the solid state battery laminate has a porosity larger than a porosity of an outer region further from the solid state battery laminate than the inner region.

5. The solid state battery according to claim 1, wherein the exterior member contains a glass component, and the one or more pores are present in the glass component.

6. The solid state battery according to claim 5, wherein the exterior member further contains an inorganic filler.

7. The solid state battery according to claim 5, wherein the glass component is at least one selected from the group consisting of silica glass, soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass.

8. The solid state battery according to claim 1, wherein the exterior member has a water vapor transmission rate of less than 1.0×10⁻³ g/(m²·Day).

9. The solid state battery according to claim 1, wherein the positive electrode layer and the negative electrode layer are layers capable of occluding and releasing lithium ions.

10. A solid state battery comprising:
a solid state battery laminate including at least one battery constituent unit, the at least one battery constituent unit including a positive electrode layer, a negative electrode layer, and a solid electrolyte layer interposed between the positive electrode layer and the negative electrode layer;
a first external terminal on a first side surface of the solid state battery laminate;
a second external terminal on a second side surface of the solid state battery laminate, the second side surface facing the first side surface across the solid state battery laminate; and
an exterior member covering the solid state battery laminate, wherein the exterior member includes at least a first exterior member layer and a second exterior member layer, the first exterior member layer located adjacent to the solid state battery laminate and including one or more pores, the second exterior member layer located adjacent to a side of the first exterior member layer opposite to the solid state battery laminate.

11. The solid state battery according to claim 10, wherein the one or more pores are present at a ratio of 2% to 20% with respect to a total area of the first exterior member layer in a sectional view thereof.

12. The solid state battery according to claim 10, wherein the second exterior member layer includes one or more pores, a ratio of a porosity of the first exterior member layer with respect to a total area of the first exterior member layer/a porosity of the second exterior member layer with respect to a total area of the second exterior member layer in a sectional view thereof is 1.1 or more.

13. The solid state battery according to claim 10, wherein the exterior member has a structure of two or more layers.

14. The solid state battery according to claim 10, wherein each of the first exterior member layer and the second exterior member layer contains a glass component, and the one or more pores are present in the glass component of the first exterior member layer.

15. The solid state battery according to claim 14, wherein the glass component is at least one selected from the group consisting of silica glass, soda lime glass, potash glass, borate-based glass, borosilicate-based glass, barium borosilicate-based glass, zinc borate-based glass, barium borate-based glass, bismuth borosilicate-based glass, bismuth zinc borate-based glass, bismuth silicate-based glass, phosphate-based glass, aluminophosphate-based glass, and zinc phosphate-based glass.

16. The solid state battery according to claim 14, wherein each of the first exterior member layer and the second exterior member layer further contains an inorganic filler.

17. The solid state battery according to claim 14, wherein either one of the first exterior member layer and the second exterior member layer contains an inorganic filler.

18. The solid state battery according to claim 10, wherein the exterior member has a water vapor transmission rate of less than 1.0×10⁻³ g/(m²·Day).

19. The solid state battery according to claim 10, wherein the positive electrode layer and the negative electrode layer are layers capable of occluding and releasing lithium ions.
